(19) United States
(12) Patent Application Publication
(10) Pub. No.: US 2018/0067244 A1
(43) Pub. Date: Mar. 8, 2018

(54) Optical Member and Window Material

(71) Applicant: Dexerials Corporation, Tokyo (JP)

(72) Inventors: Atsushi SHIBUYA., Tokyo (JP); Tsutomu NAGAHAMA., Utsunomiya-shi. (JP)

(73) Assignee: Dexerials Corporation, Tokyo (JP)

(21) Appl. No.: 15/692,113

(22) Filed: Aug. 31, 2017

(30) Foreign Application Priority Data
Sep. 6, 2016 (JP) 2016-173950

(51) Int. Cl. G02B 5/26; B32B 15/08; B32B 15/20; B32B 17/06; B32B 27/20; B32B 27/30; B32B 27/36; B32B 7/12; E06B 3/67; E06B 9/24; G02B 27/12; G02B 5/02; G02B 5/04; G02B 5/124; G02B 5/20

(52) U.S. Cl. CPC G02B 5/26; G02B 5/208; B32B 15/20; B32B 17/064; B32B 27/20; B32B 27/308; B32B 27/365; B32B 7/12; E06B 3/6715; E06B 9/24; G02B 27/126; G02B 5/0231; G02B 5/0294; G02B 5/045; G02B 5/124; B32B 15/08

(57) ABSTRACT

Provided is an optical member including: an optical layer including a first optical layer having a surface with a concave-convex shape, a reflective layer disposed on the surface with the concave-convex shape of the first optical layer, and a second optical layer disposed on the reflective layer; a first transparent substrate disposed on a side of the first optical layer included in the optical layer; and a second transparent substrate disposed on a side of the second optical layer included in the optical layer. The reflective layer is configured to reflect near-infrared light, and the first transparent substrate and the second transparent substrate are made of a same material. The optical member has a total thickness of not more than 125 μm, a breaking strength of not less than 100 N, and a break elongation both before and after a weatherability test of not less than 60%.

### TECHNICAL FIELD

The present disclosure relates to an optical member and a window material.

### BACKGROUND

In recent years, building glass, which may be used for high-rise buildings and houses, and window glass, which may be used for vehicles, are required to selectively absorb or reflect some of sun-light. For instance, such glass may be required to transmit light in the visible region for maintaining transparency of the glass and also to block light in the near-infrared region for preventing an increase in indoor temperature.

In the above regard, methods of transmitting light in the visible region and also blocking light in the near-infrared region may include a method of providing the glass with a layer having a high light reflectance in the near-infrared region.

The above method is described in some documents. Patent Literature 1, for example, describes a solar control film that has well-balanced visible light transmittance and solar reflectance. The disclosed solar control film is obtained by disposing, on a surface of a single polyester substrate, a laminated film having a five-layered structure including some layers made of an oxide of zinc and a metallic element other than zinc and other layers made of a silver alloy containing at least one type of metal selected from palladium and gold.

As another document describing the above method, Patent Literature 2, for example, describes an optical film that selectively orients and reflects light in a specific wavelength range and transmits light outside the specific wavelength range. The described optical film is obtained by forming, on an optical layer having a predetermined concave-convex shape, a wavelength-selective reflective layer. The described optical film may be attached to a window appropriately so as to reflect near-infrared light to any direction. This is described to prevent an increase in ambient temperature, which accelerates a heat island effect.

### CITATION LIST

### Patent Literatures

PTL 1: Japanese Patent Application Publication No. 2012-037634
PTL2: Japanese Patent Application Publication No. 2010-160467

### SUMMARY

However, the solar control film described in Patent Literature 1 poses the following problem. That is to say, since the polyester substrate deteriorates easily due to exposure to ultraviolet rays, applying the solar control film to window glass or the like results in a deteriorated glass scattering prevention performance over time. Additionally, the deterioration of the polyester film in the above solar control film may be prevented to some extent, for example, by disposing the laminated film on the outdoor side of the polyester film. Nevertheless, the above measures do not sufficiently reflect the concern about the glass scattering prevention performance.

Similarly, the optical film described in Patent Literature 2 deteriorates easily due to lack of preventive measures against ultraviolet rays. This poses the problem that applying the optical film to window glass or the like results in a deteriorated glass scattering prevention performance over time. Furthermore, the present inventors have conducted earnest studies and found that, when the optical film described in Patent Literature 2 is subjected to a water application operation, in which the optical film is applied to a subject of application, such as window glass, with use of water, water tends to remain. The residual water, which adversely affects appearance of a window material, needs to be avoided.

The present disclosure has been conceived in view of the above circumstances. The present disclosure is to provide an optical member and a window material including the optical member that provide excellent workability of water application with respect to the subject of application, such as window glass, and that also exhibit a high glass scattering prevention performance over long-term use.

The present inventors have repeated earnest studies to solve the above problems. As a result, the present inventors have found that the aforementioned conventional optical film has poor workability of water application because of the thickness thereof. Based on the above knowledge, the present inventors have found the following. That is to say, at least by using at least two substrates made of predetermined materials and optimizing the total thickness and also by providing the optical member with predetermined mechanical performances, excellent workability of water application and a high glass scattering prevention performance are imparted to the optical member for a long period of time. Thus, the present inventors have completed the present disclosure.

The present disclosure is based on the above findings of the present inventors, and some aspects of the present disclosure for solving the aforementioned problems reside in the following.

[1] An optical member, including: an optical layer including a first optical layer having a surface with a concave-convex shape, a reflective layer disposed on the surface with the concave-convex shape of the first optical layer, and a second optical layer disposed on the reflective layer; a first transparent substrate disposed on a side of the first optical layer included in the optical layer; and a second transparent substrate disposed on a side of the second optical layer included in the optical layer. The reflective layer is configured to reflect near-infrared light, and the first transparent substrate and the second transparent substrate are made of a same material. The optical member has a total thickness of not more than 125 μm, a breaking strength of not less than 100 N, and a break elongation before a weatherability test of not less than 60% and a break elongation after the weatherability test of not less than 60%.
[2] The optical member according to [1] on the above, wherein one of the first transparent substrate and the second transparent substrate has a thickness greater than a thickness of another one of the first transparent substrate and the second transparent substrate, and the thickness of the one of the first transparent substrate and the second transparent substrate is not less than 50 μm.
[3] The optical member according to [1] or [2] on the above, wherein the concave-convex shape of the first optical layer includes one of a prism shape, a lenticular shape, a semi-spherical shape, and a corner-cube shape, which is configured by a one-dimensional array or a two-dimensional array of a plurality of structures.
[4] The optical member according to any one of [1] to [3] on the above, wherein the first optical layer and the second optical layer each contain one of a thermoplastic resin, an active energy ray-curable resin, and a thermosetting resin.
[5] The optical member according to any one of [1] to [4] on the above, wherein at least one of the first optical layer and the second optical layer contains a ultraviolet absorbing agent.
[6] The optical member according to any one of [1] to [5] on the above, wherein the first optical layer and the second optical layer each have a storage modulus of not less than 1.0 GPa and not more than 4.5 GPa at 25° C. at 1 Hz.
[7] The optical member according to any one of [1] to [6] on the above, wherein a laminated body of the optical layer and the second transparent substrate has a transmittance of not more than 20% for ultraviolet rays with wavelengths of not less than 300 nm and not more than 325 nm.
[8] A window material including the optical member according to any one of [1] to [7] on the above.

The present disclosure provides an optical member and a window material including the optical member that provide excellent workability of water application with respect to a subject of application, such as window glass, and that also exhibit a high glass scattering prevention performance over long-term use.

### BRIEF DESCRIPTION OF THE DRAWINGS

In the accompanying drawings:

FIG. 1A is a sectional view illustrating a configuration example of an optical member according to one of embodiments;

FIG. 1B is a sectional view illustrating an example in which an optical member of FIG. 1A is applied to a subject of application;

FIG. 2A is a perspective view illustrating an example of the shape of a structure formed in a first optical layer of an optical member according to one of embodiments;

FIG. 2B is a perspective view illustrating another example of the shape of a structure formed in a first optical layer of an optical member according to one of embodiments;

FIG. 2C is a perspective view illustrating yet another example of the shape of a structure formed in a first optical layer of an optical member according to one of embodiments;

FIG. 3A is a plan view illustrating a configuration example of a structure formed in a first optical layer of an optical member according to one of embodiments;

FIG. 3B is a sectional view taken along a line B-B of a first optical layer illustrated in FIG. 3A;

FIG. 3C is a sectional view taken along a line C-C of a first optical layer illustrated in FIG. 3A;

FIG. 4A is a plan view illustrating another configuration example of a structure formed in a first optical layer of an optical member according to one of embodiments;

FIG. 4B is a sectional view taken along a line B-B of a first optical layer illustrated in FIG. 4A;

FIG. 4C is a sectional view taken along a line C-C of a first optical layer illustrated in FIG. 4A;

FIG. 5A is a plan view illustrating yet another configuration example of a structure formed in a first optical layer of an optical member according to one of embodiments;

FIG. 5B is a sectional view taken along a line B-B of a first optical layer illustrated in FIG. 5A;

FIG. 6A is a schematic view illustrating an example of a method of applying an optical member according to one of embodiments;

FIG. 6B is another schematic view illustrating an example of a method of applying an optical member according to one of embodiments;

FIG. 7 is a schematic view illustrating a configuration example of an apparatus used to produce an optical member according to one of embodiments;

FIG. 8A is a process view illustrating an example of a method of producing an optical member according to one of embodiments;

FIG. 8B is another process view illustrating an example of a method of producing an optical member according to one of embodiments;

FIG. 8C is yet another process view illustrating an example of a method of producing an optical member according to one of embodiments;

FIG. 9A is yet another process view illustrating an example of a method of producing an optical member according to one of embodiments;

FIG. 9B is yet another process view illustrating an example of a method of producing an optical member according to one of embodiments;

FIG. 9C is yet another process view illustrating an example of a method of producing an optical member according to one of embodiments;

FIG. 10C is yet another process view illustrating an example of a method of producing an optical member according to one of embodiments;

FIG. 10B is yet another process view illustrating an example of a method of producing an optical member according to one of embodiments; FIG. 10C is yet another process view illustrating an example of a method of producing an optical member according to one of embodiments; and

FIG. 11 is a schematic view illustrating an example of an apparatus used to measure stiffness of an optical member.

### DETAILED DESCRIPTION

The present disclosure will be described concretely below based on preferred embodiments.

### (Optical Member)

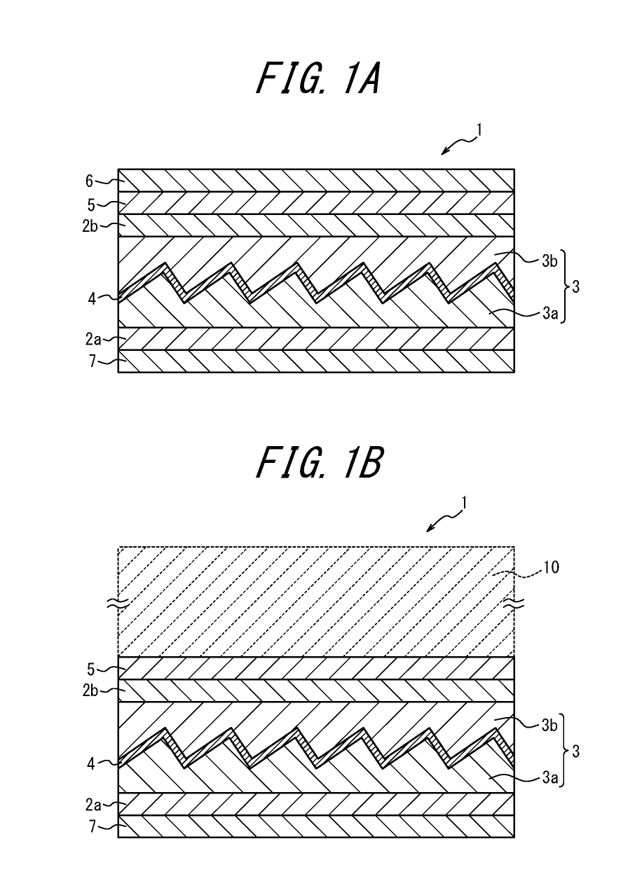

FIG. 1A is a sectional view illustrating a configuration example of an optical member according to one of embodiments. FIG. 1B is a sectional view illustrating an example in which an optical member of FIG. 1A is applied to a subject of application. An optical member 1 includes a first transparent substrate 2a, an optical layer 3, which is disposed on one surface of the first transparent substrate 2a, and a second transparent substrate 2b, which is disposed on the optical layer 3. The optical member 1 has a total thickness of not more than 125 μm. Herein, the optical layer 3 includes a first optical layer 3a, which has a surface (concave-convex surface) having a concave-convex shape, a reflective layer 4, which is disposed on the concave-convex surface of the first optical layer 3a, and a second optical layer 3b, which is disposed on the reflective layer 4.

Additionally, the optical member 1 is normally to be applied to a subject 10 of application, such as window glass in a manner such that the first transparent substrate 2a is disposed on the indoor side of the second transparent substrate 2b and that the first optical layer 3a is disposed on the indoor side of the second optical layer 3b.

### <First Transparent Substrate and Second Transparent Substrate>

The first transparent substrate 2a is disposed on the side of the first optical layer 3a, which is included in the optical layer 3, in the optical member 1. The second transparent substrate 2b is disposed on the side of the second optical layer 3b, which is included in the optical layer 3, in the optical member 1. The second transparent substrate 2b, which is normally disposed on the outdoor side, serves to absorb ultraviolet rays to a certain extent to protect other layers, including the first transparent substrate 2a on the indoor side, against ultraviolet rays. In cooperation with the aforementioned function of the second transparent substrate 2b, the first transparent substrate 2a serves to maintain a high glass scattering prevention performance for a long period of time.

The first transparent substrate 2a and the second transparent substrate 2b are characterized in that they are made of the same material. Due to the fact that the first transparent substrate 2a and the second transparent substrate 2b are made of the same material, light that may deteriorate the first transparent substrate 2a and light that may deteriorate the second transparent substrate 2b are in the same wavelength region. Accordingly, the transparent substrate to be disposed on the outdoor side that serves to absorb ultraviolet rays effectively prevents deterioration due to ultraviolet rays of the transparent substrate to be disposed on the indoor side that is made of the same material.

The first transparent substrate 2a and the second transparent substrate 2b are preferably shaped in the form of a film or a sheet with a view to imparting flexibility to the optical member 1. However, the first transparent substrate 2a and the second transparent substrate 2b do not necessarily need to be shaped as described above.

As the material of the first transparent substrate 2a and the second transparent substrate 2b, for example, a known high polymeric material may be used. Examples of the known high polymeric material may include triacetyl cellulose (TAC), polyester (TPEE), polyethylene terephthalate (PET), polyimide (PI), polyamide (PA), aramid, polyethylene (PE), polyacrylate, polyethersulfone, polysulfone, polypropylene (PP), diacetyl cellulose, polyvinyl chloride, an acrylic resin (PMMA), polycarbonate (PC), an epoxy resin, a urea resin, an urethane resin, and a melamine resin. However, the material is not particularly limited to any of the above examples.

The first transparent substrate 2a may have any thickness, with which a total thickness of the optical member 1 is not more than 125 μm. However, when, for example, the optical member 1 is applied to a window material or the like, with the first transparent substrate 2a being disposed on the indoor side of the second transparent substrate 2b, the first transparent substrate 2a preferably has a thickness of not more than 60 μm. When the thickness of the first transparent substrate 2a in the optical member 1 is not more than 60 μm, it is further ensured that both the workability of water application and the glass scattering prevention performance with respect to a subject of application, such as window glass, may be achieved. From the same perspective, the thickness of the first transparent substrate 2a is preferably not more than 55 μm and more preferably not more than 50 μm.

On the other hand, the lower limit of the thickness of the first transparent substrate 2a is not particularly limited to any value. From the viewpoint of productivity, however, the thickness of the first transparent substrate 2a is preferably not less than 38 μm.

The second transparent substrate 2b may have any thickness, with which the total thickness of the optical member 1 is not more than 125 μm. However, when, for example, the optical member 1 is applied to a window material or the like, with the second transparent substrate 2b being disposed on the outdoor side of the first transparent substrate 2a, the second transparent substrate 2b preferably has a thickness of not more than 30 μm. When the thickness of the second transparent substrate 2b in the optical member 1 is not more than 30 μm, it is further ensured that both the workability of water application and the glass scattering prevention performance with respect to a subject of application, such as window glass, may be achieved. From the same perspective, the thickness of the second transparent substrate 2b is preferably not more than 25 μm and more preferably not more than 23 μm.

On the other hand, the lower limit of the thickness of the second transparent substrate 2b is not particularly limited to any value. With the view to protecting the first transparent substrate 2a against ultraviolet rays and maintaining a high glass scattering prevention performance over long-term use, however, the thickness of the second transparent substrate 2b is preferably not less than 20 μm.

Furthermore, in the optical member 1, the thickness of one of the first transparent substrate 2a and the second transparent substrate 2b is preferably greater than the other one and is preferably not less than 50 μm. Especially, when, for example, the optical member 1 is applied to a window material or the like, with the first transparent substrate 2a being disposed on the indoor side of the second transparent substrate 2b, the thickness of the first transparent substrate 2a is preferably greater than the thickness of the second transparent substrate 2b and is preferably not less than 50 μm. With the above configuration, even when being exposed to light, such as ultraviolet rays, the optical member 1 is prevented from deterioration. This helps maintain the glass scattering prevention performance of the optical member 1 for a long period of time.

The first transparent substrate 2a preferably has active energy ray-transmitting properties. The reason is that, as described later, an active energy ray-curable resin interposed between the first transparent substrate 2a and the reflective layer 4 may be cured by irradiating the resin with active energy rays from the side of the first transparent substrate 2a.

The second transparent substrate 2b also preferably has active energy ray-transmitting properties. The reason is that, as described later, an active energy ray-curable resin interposed between the second transparent substrate 2b and the reflective layer 4 may be cured by irradiating the resin with active energy rays from the side of the second transparent substrate 2b.

The first transparent substrate 2a and the second transparent substrate 2b preferably have water vapor permeability lower than water vapor permeability of the first optical layer 3a and the second optical layer 3b. Assume, for example, that the first optical layer 3a is formed by using an active energy ray-curable resin, such as urethane acrylate. In this case, the first transparent substrate 2a is preferably formed by using a resin, such as polyethylene terephthalate (PET), which has water vapor permeability lower than water permeability of the first optical layer 3a and which has active energy ray-transmitting properties. This reduces diffusion of moisture into the reflective layer 4, thereby preventing deterioration of metal or the like contained in the reflective layer 4. Accordingly, durability of the optical member 1 is improved. Note that the water vapor permeability of PET having a thickness of 75 μm is approximately 10 g/m²/day (40° C., 90% RH).

### <Optical Layer>

As described earlier, the optical layer 3 includes the first optical layer 3a, which has the concave-convex surface, the reflective layer 4, which is disposed on the concave-convex surface of the first optical layer 3a, and the second optical layer 3b, which is disposed on the reflective layer 4.

The optical layer 3 (i.e., a laminated body of the first optical layer 3a, the reflective layer 4, and the second optical layer 3b) preferably has transparency in the visible region. With the transparency, when the optical member 1 is applied to the subject 10 of application, such as window glass, visible light is transmitted, and lighting with sunlight is ensured. Herein, the transparency is defined as having two meanings, i.e., to absorb no light and to scatter no light. When the term transparency is generally used, it may imply the former meaning alone. However, the optical layer 3 preferably has the transparency in both the meanings. Yet, depending on intended use of the optical member 1, scattering properties may be imparted, for example, to the second optical layer 3b intentionally.

The optical layer 3 may have any thickness, with which the total thickness of the optical member 1 is not more than 125 μm. However, when, for example, the thickness of the second transparent substrate 2b is not more than 30 μm and the thickness of the first transparent substrate 2a is not more than 60 μm, the thickness of the optical layer 3 is preferably not more than 20 μm. The above configuration enhances the workability of water application with respect to the subject 10 of application, such as window glass, sufficiently.

For another example, when the thickness of the second transparent substrate 2b is not more than 25 μm and the thickness of the first transparent substrate 2a is not more than 55 μm, the thickness of the optical layer 3 is preferably not more than 30 μm. The above configuration also enhances the workability of water application with respect to the subject 10 of application, such as window glass, sufficiently.

For yet another example, when the thickness of the second transparent substrate 2b is not more than 23 μm and the thickness of the first transparent substrate 2a is not more than 50 μm, the thickness of the optical layer 3 is preferably not more than 37 μm. The above configuration also enhances the workability of water application with respect to the subject 10 of application, such as window glass, sufficiently.

### <<First Optical Layer and Second Optical Layer>>

The first optical layer 3a serves, for example, to support and protect the reflective layer 4. The first optical layer 3a is mainly made of a resin with a view to imparting flexibility to the optical member 1. As illustrated in, for example, FIG. 1A, one of both main surfaces of the first optical layer 3a is a flat surface, and the other one thereof is the concave-convex surface (which may be called a first surface). The reflective layer 4 is disposed on the concave-convex surface of the first optical layer 3a.

The second optical layer 3b serves to protect the reflective layer 4 by embedding the first surface (concave-convex surface) of the first optical layer 3a on which the reflective layer 4 is formed. The second optical layer 3b is mainly made of, for example, a resin with a view to imparting flexibility to the optical member 1. As illustrated in, for example, FIG. 1A, one of both main surfaces of the second optical layer 3b is a flat surface, and the other one thereof is a concave-convex surface (which may be called a second surface). The concave-convex surface of the first optical layer 3a and the concave-convex surface of the second optical layer 3b have a relation in which the concave-convex shapes are reversed relative to each other.

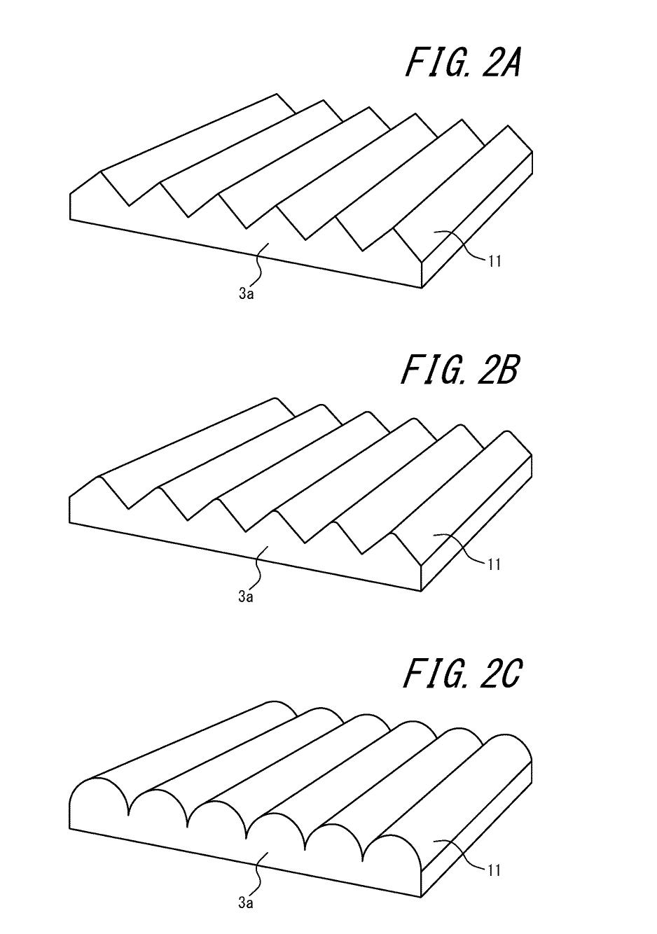

The concave-convex shape of the first optical layer 3a may be configured, for example, by a one-dimensional array of a plurality of structures. FIGS. 2A to 2C are perspective views illustrating examples of the shapes of structures formed one-dimensionally in the first optical layer 3a. Each structure 11 is a columnar convex portion extending in one direction. The columnar structures 11 are arranged one-dimensionally along another direction. Since the reflective film 4 is formed on the structures 11, the reflective film 4 has the same shape as the surface shape of the structures 11.

Each of the one-dimensionally formed structures 11 may have a prism shape as illustrated in FIG. 2A, a lenticular shape as illustrated in FIG. 2C, a semi-spherical shape, a corner-cube shape, a shape obtained by reversing one of these shapes, or the like. Herein, when the structure 11 has a corner as in, for example, the prism shape, the corner may be rounded (refer to FIG. 2B). The concave-convex shape of the first optical layer 3a as listed above allows the reflective layer 4, which is formed on the first optical layer 3a, to orient and reflect near-infrared light. Accordingly, by applying the optical member 1 to the subject 10 of application, such as window glass, appropriately, an increase in ambient temperature, which accelerates the heat island effect, is prevented. Additionally, the shape of each of the one-dimensionally formed structures 11 is not limited to any of the shapes illustrated in FIGS. 2A to 2C or any of reversed shapes thereof and may be a toroidal shape, a hyperbolic columnar shape, an elliptic columnar shape, a polygonal columnar shape, or a free-form shape.

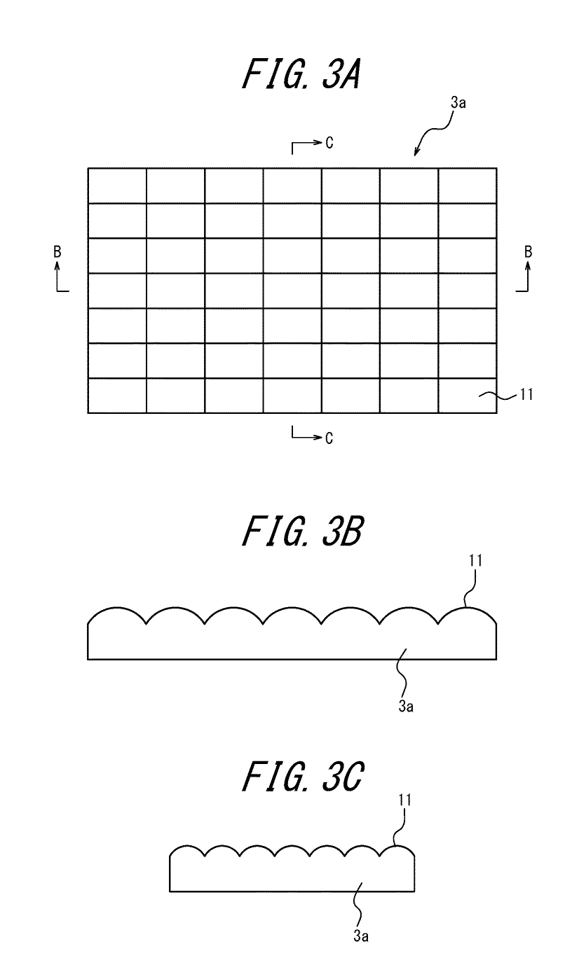

The concave-convex shape of the first optical layer 3a may also be configured, for example, by a two-dimensional array of a plurality of structures. FIGS. 3A to 5B are plan views and sectional views illustrating configuration examples of structures formed two-dimensionally in the first optical layer 3a. The two-dimensional array is preferably an array in a closest-packed state. For example, by arranging the structures 11 two-dimensionally in the closest-packed state, a close-packed array, such as a quadrangular close-packed array, a delta closed-packed array, and a hexagonal close-packed array, may be formed on one main surface of the first optical layer 3a. In the quadrangular close-packed array, the structures 11, each having a rectangular bottom surface, are arranged in a quadrangular closest-packed state. In the delta close-packed array, the structures 11, each having a triangular bottom surface, are arranged in a hexagonal closest-packed state. In the hexagonal close-packed array, the structures 11, each having a hexagonal bottom surface, are arranged in a hexagonal closest-packed state. Since the reflective film 4 is formed on the structures 11, the reflective film 4 has the same shape as the surface shape of the structures 11.

Each of the two-dimensionally formed structures 11 may have a prism shape, a lenticular shape, a semi-spherical shape, a corner-cube shape, or the like. The concave-convex shape of the first optical layer 3a as listed above allows the reflective layer 4, which is formed on the first optical layer 3a, to orient and reflect near-infrared light. Accordingly, by applying the optical member 1 to the subject 10 of application, such as window glass, appropriately, an increase in ambient temperature, which accelerates the heat island effect, is prevented. Additionally, the shape of each of the two-dimensionally formed structures 11 is not limited to any of the above examples and may be a semi-ellipsoidal shape, a free-form shape, a polygonal columnar shape, a conical shape, a polygonal pyramid shape, a frusto-conical shape, a parabolic shape, or the like.

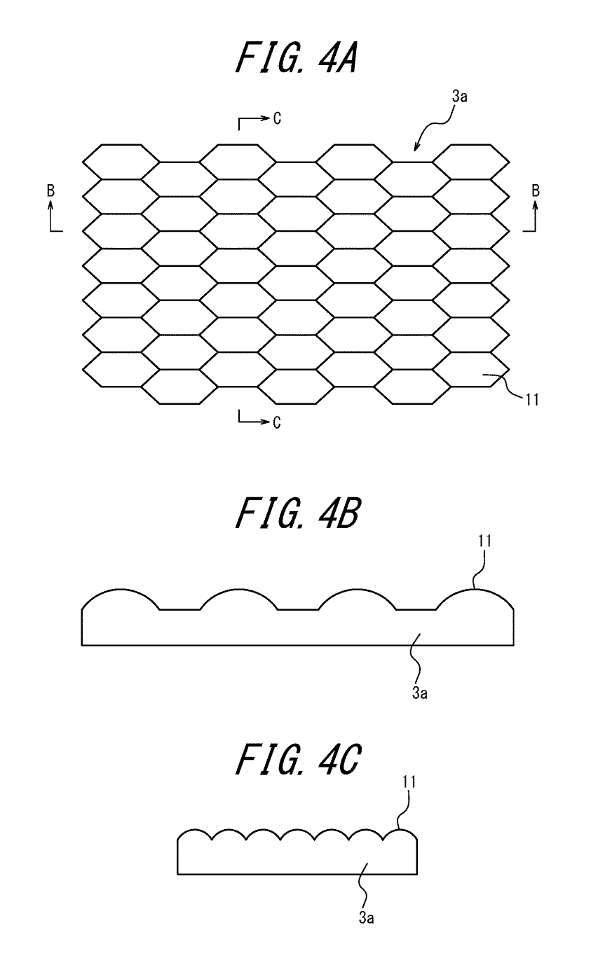

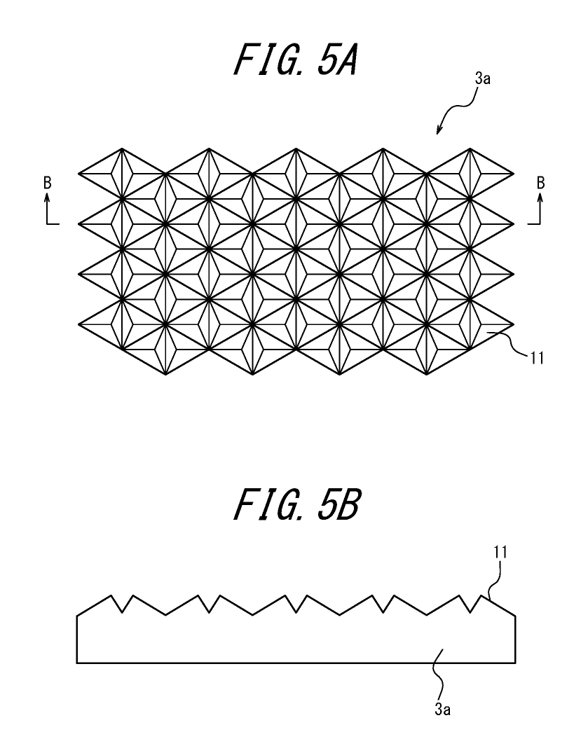

Each structure 11 have a bottom surface that has, for example, a circular shape, an elliptic shape, or a polygonal shape, such as a triangular, a rectangular, a hexagonal, and an octagonal shape. FIGS. 3 A to 3C illustrate an example of the quadrangular closed-packed array, in which the structures 11, each having a rectangular bottom surface, are arranged two-dimensionally in the closest-packed state. FIGS. 4 A to 4C illustrate an example of the delta close-packed array, in which the structures 11, each having a hexagonal bottom surface, are arranged two-dimensionally in the closest-packed state. FIGS. 5 A and 5B illustrate an example of the hexagonal close-packed array, in which the structures 11, each having a triangular bottom surface, are arranged two-dimensionally in the closest-packed state.

The first optical layer 3a and the second optical layer 3b have, for example, transparency. The first optical layer 3a and the second optical layer 3b may each be obtained, for example, by curing a resin composition. From the perspective of easy production, the resin composition preferably contains a thermoplastic resin, an active energy ray-curable resin that is curable by light, electron rays, or the like, or a thermosetting resin that is curable by heat. In other words, the first optical layer 3a and the second optical layer 3b preferably contain one of a thermoplastic resin, an active energy ray-curable resin, and a thermosetting resin. Examples of active energy rays may include electron rays, ultraviolet rays, visible rays, and gamma rays. Additionally, as an active energy ray-curable resin, a photosensitive resin that is curable by light is preferably used, and an ultraviolet ray-curable resin that is curable by ultraviolet rays is more preferably used from the perspective of production facilities.

Furthermore, the above resins may be used alone or in a combination of two or more.

Examples of an ultraviolet ray-curable resin may include (meth)acrylate. The resin composition containing an ultraviolet ray-curable resin contains, for example, (meth)acrylate and a photoinitiator. The resin composition containing an ultraviolet ray-curable resin may further contain a photo-stabilizer, a flame retardant, a leveling agent, an anti-oxidant, or the like, as needed.

As (meth)acrylate, a monomer and/or an oligomer having two or more (meth)acryloyl groups are(is) preferably used. Examples of such a monomer and/or oligomer may include urethane (meth)acrylate, benzyl (meth)acrylate, epoxy (meth)acrylate, polyester (meth)acrylate, polyol (meth)acrylate, polyether (meth)acrylate, and melamine (meth)acrylate. Herein, the term (meth)acryloyl group refers to at least one of an acryloyl group and a methacryloyl group.

The photoinitiator used here may be selected from among known materials as appropriate. Examples of the known materials may include benzophenone derivatives, acetophenone derivatives, and anthraquinone derivatives, and these may be used alone or in combination. The amount of the photoinitiator is preferably not less than 0.1 mass % and not more than 10 mass % of the solid content. With an amount of less than 0.1 mass %, photo-curability is lowered to a level that is practically unsuitable for industrial production. On the other hand, with an amount of more than 10 mass %, an odor tends to remain in a coat when the amount of irradiation light is insufficient. Herein, the term solid content refers to all components constituting the first optical layer 3a or the second optical layer 3b after curing. For example, (meth)acrylate, the photoinitiator, and the like may be called the solid content.

Any resin used in the first optical layer 3a and the second optical layer 3b preferably allows the structures to be transferred to the resin by irradiation with active energy ray or by heat. Any resin, such as a vinyl-based resin, an epoxy-based resin, and a thermoplastic resin, which allows formation of the desired concave-convex surfaces in the first optical 3a and the second optical layer 3b, may be used.

The resin composition may contain an oligomer to reduce curing shrinkage. The resin composition may further contain, for example, polyisocyanate as a curing agent. For the sake of adhesion between the first optical layer 3a and the second optical layer 3b, the resin composition may further contain a monomer having a hydroxyl group, a carboxyl group, or a phosphoric group, polyalcohols, coupling agents such as carboxylic acid, silane, aluminum, and titanium, various chelating agents, or the like.

Preferably, the resin composition further contains a cross-linking agent. The cross-linking agent contained in the resin composition provides heat-resistant properties to the resin without significantly changing the storage modulus at room temperature. Note that a significant change in storage modulus at room temperature makes the optical member 1 brittle, thereby possibly making it difficult to fabricate the optical member 1 by a roll-to-roll process. As the cross-linking agent, a cyclic cross-linking agent is preferably used. Examples of the cyclic cross-linking agent may include dioxaneglycol diacrylate, tricyclodecanedimethanol diacrylate, tricyclodecanedimethanol dimethacrylate, ethylene oxide-modified isocyanurate diacrylate, ethylene oxide-modified isocyanurate triacrylate, and caprolactone-modified tris(acryloxyethyl) isocyanurate.

Preferably, the resin composition further contains an ultraviolet absorbing agent. In other words, at least one of the first optical layer 3a and the second optical layer 3b preferably contains an ultraviolet absorbing agent. Since the optical member 1 according to the present embodiment has a total thickness of 125 μm, which is less than that of a conventional one, the thickness of the second transparent substrate 2b to be disposed on the outdoor side is restricted. The optical member 1 is therefore relatively susceptible to deterioration due to ultraviolet rays. For the above reason, when at least one of the first optical layer 3a and the second optical layer 3b contains an ultraviolet ray absorbing agent, the deterioration due to ultraviolet rays is prevented more effectively, and an even higher glass scattering prevention performance is maintained over long-term use.

Examples of the ultraviolet ray absorbing agent may include the one having an absorption peak in a wavelength range of not less than 300 nm and not more than 325 nm. In view of heat resistance and retention, an triazine-based ultraviolet ray absorbing agent is especially preferable.

From the perspective of achieving a sufficient ultraviolet ray absorbing effect efficiently, the content of the ultraviolet ray absorbing agent in the first optical layer 3a and/or the second optical layer 3b is preferably not less than 0.5 mass % and is also preferably not more than 5 mass %, when, for example, the thickness of the second transparent substrate 2b is not more than 30 μm. Similarly, from the same perspective, the content is preferably not less than 0.8 mass % and is also preferably not more than 5 mass %, when, for example, the thickness of the second transparent substrate 2b is not more than 25 μm.

The first optical layer 3a and the second optical layer 3b preferably have the same optical characteristics, such as refractive index. In more detail, the first optical layer 3a and the second optical layer 3b are preferably made of the same material, e.g., the same resin material. When the first optical layer 3a and the second optical layer 3b are configured by using the same material, the layers 3a and 3b have the same refractive index. This improves transparency to visible light. It is to be noted, however, that, even with the same starting material, the resulting final layers may have different refractive indices depending on, for example, curing conditions in film formation processes. On the other hand, when the first optical layer 3a and the second optical layer 3b are configured by using different materials, the layers 3a and 3b have different refractive indices. This leads to a tendency for light to be refracted at the reflective layer 4, resulting in a blurred transmitted image. An observed diffraction pattern tends to be noticeable when an object located near a point light source, such as a distant electric light, is observed. Additionally, to control a refractive index value, an additive may be added to the first optical layer 3a and/or the second optical layer 3b.

The first optical layer 3a and the second optical layer 3b each have a storage modulus of not less than 1.0 GPa and not more than 4.5 GPa at 25° C. at 1 Hz. When the storage modulus of each of the first optical layer 3a and the second optical layer 3b is not less than 1.0 GPa, the optical member 1 is imparted with a sufficient breaking strength, which provides a sufficiently high glass scattering prevention performance in an initial state. Furthermore, when the storage modulus of each of the first optical layer 3a and the second optical layer 3b is not more than 4.5 GPa, the optical member 1 is imparted with favorable flexibility and break elongation. This allows production of the optical member 1 by the roll-to-roll process and also improves the glass scattering prevention performance in the initial state sufficiently. From the same perspective, the storage modulus of each of the first optical layer 3a and the second optical layer 3b at 25° C. at 1 Hz is more preferably not more than 3.5 GPa, even more preferably not more than 2.0 GPa.

Additionally, the storage modulus of each of the first optical layer 3a and the second optical layer 3b may be controlled, for example, by adjusting the length of a side chain of a resin used for the fabrication or selecting the type of resin as appropriate. For example, when a thermoplastic resin is used, the method of controlling the length and the type of the side chain may be employed. When a thermosetting resin and an active energy ray-curable resin are used, the method of controlling the number of cross-linking points and the molecular structure of the cross-linking agent may be employed. However, it is preferable for such a structural change not to degrade the characteristics required for the resin material itself. For example, depending on the type of the cross-linking agent, the storage modulus may be increased to such a level where the optical member 1 becomes brittle or where the optical member 1 is curved or curled due to increased shrinkage. Accordingly, the type of the cross-linking agent is preferably selected as appropriate in accordance with desired characteristics.

The storage modulus of each of the first optical layer 3a and the second optical layer 3b may be measured according to a method described with respect to Examples.

Additionally, when, for example, the storage modulus of each of the first optical layer 3a and the second optical layer 3b at 25° C. at 1 Hz is more than 3.5 GPa and not more than 4.5 GPa, the thickness of the optical layer 3 (i.e., the laminated body of the first optical layer 3a, the reflective layer 4, and the second optical layer 3b) is preferably not more than 30 μm. The above configuration sufficiently improves the glass scattering prevention performance of the optical member 1 in the initial state.

For another example, when the storage modulus of each of the first optical layer 3a and the second optical layer 3b at 25° C. at 1 Hz is more than 2.0 GPa and not more than 3.5 GPa, the thickness of the optical layer 3 (i.e., the laminated body of the first optical layer 3a, the reflective layer 4, and the second optical layer 3b) is preferably not more than 50 μm. The above configuration sufficiently improves the glass scattering prevention performance of the optical member 1 in the initial state.

For yet another example, when the storage modulus of each of the first optical layer 3a and the second optical layer 3b at 25° C. at 1 Hz is not more than 2.0 GPa, the thickness of the optical layer 3 (i.e., the laminated body of the first optical layer 3a, the reflective layer 4, and the second optical layer 3b) is preferably not more than 70 μm. The above configuration sufficiently improves the glass scattering prevention performance of the optical member 1 in the initial state.

### <<Reflective Layer>>

The reflective layer 4 has properties to reflect near-infrared light in light incident on an incident surface. For example, to further impart the reflective layer 4 with properties to block ultraviolet rays, the reflective layer 4 may be configured by alternatively laminating, for example, a sub-layer made of a silver alloy and a sub-layer made of a metal oxide, such as niobium oxide, tantalum oxide, titanium oxide, and aluminium zinc oxide. Herein, examples of a silver alloy may include AgPdCu, AgPdTi, AgCuTi, AgPdCa, AgPdMg, and AgPdFe. To reduce corrosion, a material such as Ti and Nd is preferably added to the sub-layer made of a silver alloy.

For each of the sub-layer made of a silver alloy and the sub-layer made of a metal oxide, one kind or a combination of two or more kinds may be used.

In the present disclosure, “near-infrared light” refers to any light in a wavelength band of from 780 nm to 2500 nm. In the present disclosure, the phrase “reflect near-infrared light” means that a light reflectance in a certain wavelength of near-infrared light, e.g., a wavelength of 1500 nm, is not less than 20%.

The reflective layer 4 may further include a barrier layer. The barrier layer may be formed by using, for example, an inorganic oxide containing at least one of alumina (Al₂O₃), silica (SiOₓ), and zirconia, or, a resin material containing at least one of polyvinylidene chloride (PVDC), polyvinyl fluoride, and a partial hydrolysate of ethylene-vinyl acetate copolymer (EVOH). The barrier layer may also be formed by using a dielectric material containing at least one of SiN, ZnS—SiO₂, AlN, Al₂O₃, SiO₂—Cr₂O₃—ZrO₂ (SCZ), SiO₂—In₂O₃—ZrO₂ (SIZ), TiO₂, and Nb₂O₅.

### <Other Layers>

The optical member 1 may further include other layers as described below, in addition to those described above.

For example, the optical member 1 may further include an application layer 5 as illustrated in FIG. 1A, as needed. The application layer 5 is disposed on a surface of the optical member 1 that is to be applied to the subject 10 of application. In this example, as illustrated in FIG. 1B, the optical member 1 is to be applied to the indoor side or the outdoor side of the subject 10 of application, such as window glass, via the application layer 5. The application layer 5 may be formed, for example, as a bonding layer containing a bonding agent (such as a UV-cured resin and a two-liquid mixed resin) as a main component, or as an adhesive layer containing an adhesive (such as a Pressure Sensitive Adhesive [PSA]) as a main component. When the application layer 5 is the adhesive layer, the optical member 1 preferably further include a peel-off layer 6, which is formed on the application layer 5 as illustrated in FIG. 1A. The above configuration facilitates application of the optical member 1 to the subject 10 of application via the application layer 5, simply by peeling off the peel-off layer 6.

From the perspective of increasing adhesion between the second transparent substrate 2b and the application layer 5 and/or the second optical layer 3b, the optical member 1 may further include a primer layer (which is not illustrated) between the second transparent substrate 2b and the application layer 5 and/or the second optical layer 3b. Furthermore, from the perspective of increasing adhesion at the aforementioned position(s), it is preferable to carry out a known physical pretreatment instead of or in addition to forming the primer layer. Examples of the known physical pretreatment may include a plasma treatment and a corona treatment.

The optical member 1 may further include, on a surface thereof that is to be applied to the subject 10 of application, a barrier layer (which is not illustrated). The barrier layer may be formed by using, for example, an inorganic oxide containing at least one of alumina (Al₂O₃), silica (SiOₓ), and zirconia, or, a resin material containing at least one of polyvinylidene chloride (PVDC), polyvinyl fluoride, and a partial hydrolysate of ethylene-vinyl acetate copolymer (EVOH). The barrier layer may also be formed by using a dielectric material containing at least one of SiN, ZnS—SiO₂, AlN, Al₂O₃, SiO₂—Cr₂O₃—ZrO₂ (SCZ), SiO₂—In₂O₃—ZrO₂ (SIZ), TiO₂, and Nb₂O₅.

From the perspective of imparting scratch resistance to a surface, the optical member 1 may further include a hard coat layer 7 as illustrated in FIG. 1A. When the optical member 1 includes the hard coat layer 7, the hard coat layer 7 is preferably formed on a surface of the optical member 1 opposite to the surface to be applied to the subject 10 of application. The hard coat layer 7 preferably has a pencil hardness of not less than 2H, more preferably not less than 3H, from the perspective of scratch resistance. The hard coat layer 7 may be obtained, for example, by coating the surface with a resin composition and curing the resin composition. Examples of the resin composition may include the one containing an organosilane-based thermosetting resin such as methyltriethoxysilalle and phenyltriethoxysilane, a melamine-based thermosetting resin such as etherified methylolmelamine, a polyfunctional acrylate-based ultraviolet-curing resin such as polyol acrylate, polyester acrylate, urethane acrylate, and epoxy acrylate, or the like. The resin composition used to form the hard coat layer 7 may further contain an additive, such as a photo-stabilizer, a flame retardant, and anti-oxidant, as needed.

By thus including the hard coat layer 7, the optical member 1 achieves scratch resistance. Accordingly, in cases where the optical member 1 is applied, for example, to the indoor side of the subject 10 of application, the surface of the optical member 1 is protected against scratches even when it is touched by a person or cleaned. Similarly, in cases where the optical member 1 is applied to the outdoor side of the subject 10 of application, occurrence of scratches is limited.

From the perspective of imparting antifouling properties to the optical member 1, the optical member 1 may further include a layer having water-repellent or hydrophilic properties. The layer having such a function may be formed as an independent antifouling layer containing an antifouling agent. Alternatively, the antifouling agent may be added to various functional layers, such as the hard coat layer 7, to provide the antifouling function. The antifouling agent is not limited to a particular agent and may be selected appropriately according to purposes. However, it is preferable to use a silicone oligomer and/or a fluorine-containing oligomer having one or more (meth)acrylic groups, vinyl groups, or epoxy groups. The amount of a silicone oligomer and/or a fluorine-containing oligomer is preferably not less than 0.01 mass % and not more than 5 mass % of the solid content. With an amount of less than 0.01 mass %, the antifouling function tends to be insufficient. On the other hand, with an amount of more than 5 mass %, the coating hardness tends to decrease. Examples of the antifouling agent may include RS-602 and RS-751-K manufactured by DIC Corporation, CN4000 manufactured by Sartomer Company, Inc., OPTOOL DAC-HP manufactured by Daikin Industries, Ltd., X-22-164E manufactured by Shin-Etsu Chemical Co., Ltd., FM-7725 manufactured by Chisso Corporation, EBECRYL 350 manufactured by Daicel-Cytec Company, Ltd., and TEGORAD 2700 manufactured by Degussa Corporation. When the hard coat layer 7 has the antifouling function, the antifouling hard coat layer 7 preferably has a pure water contact angle of not less than 70°, more preferably not less than 90°. When, for example, the antifouling layer is formed independently on the hard coat layer 7, the optical member 1 may further include a coupling agent layer (primer layer) disposed between the hard coat layer 7 and the antifouling layer from the perspective of improving adhesion between the hard coat layer 7 and the antifouling layer.

<Properties Etc. Of Optical Member>

From the perspective of facilitating application of the optical member 1 to the subject 10 of application, the optical member 1 is preferably in the form of a film or a sheet that has flexibility.

Furthermore, the optical member 1 as a whole preferably has a strip or a rectangular shape. The above shape allows easy production of the optical member 1 by the roll-to-roll process. When being wound into a roll, the optical member 1 is easy to handle.

The optical member 1 needs to have a total thickness of not more than 125 μm. When the total thickness of the optical member 1 is more than 125 μm, it is difficult to drain water in cases of a water application operation, in which the optical member 1 is applied to the subject of application, such as window glass. This leads to poor appearance. On the other hand, when the total thickness of the optical member 1 is not more than 125 μm, residual water is reduced even in cases of the water application operation, in which the optical member 1 is applied to the subject of application, such as window glass. This helps maintain favorable appearance of a window material or the like. Furthermore, from the perspective of further enhancing the workability of water application with respect to the subject 10 of application, such as window glass, the total thickness of the optical member 1 is preferably not more than 115 μm, more preferably not more than 110 μm.

Additionally, in cases where the optical member 1 includes the application layer 5 on the surface of the optical layer 1 that is to be applied to the subject 10 of application and in cases where the optical member 1 includes the peel-off layer 6 in addition to the application layer 5, the “total thickness of the optical member 1” is to be construed as not including the thicknesses of the application layer 5 and the peel-off layer 6.

The optical member 1 needs to have a break elongation before a weatherability test of not less than 60% and a break elongation after the weatherability test of not less than 60%. When the break elongation of the optical member 1 before the weatherability test is less than 60%, the glass scattering prevention performance is insufficient before use. Besides, when the break elongation of the optical member 1 before the weatherability test is less than 60%, a high glass scattering prevention performance cannot be maintained over long-term use. Likewise, from the perspective of further enhancing the glass scattering prevention performance before use, the break elongation of the optical member 1 before the weatherability test is more preferably not less than 70%. From the perspective of further enhancing the glass scattering prevention performance over long-term use, the break elongation of the optical member 1 after the weatherability test is more preferably not less than 60%.

Additionally, the break elongation of the optical member 1 after the weatherability test may be controlled, for example, by adjusting the total thickness of the optical member 1, by selecting the first optical layer 3a and/or the second optical layer 3b as appropriate while focusing attention on the storage moduli thereof, or by adding the ultraviolet ray absorbing agent to the first optical layer 3a and/or the second optical layer 3b.

Herein, the “weatherability test” in the present disclosure refers to the “test in which a sample is irradiated with ultraviolet rays for 500 hours under the conditions of an illuminance of 650 W/m² and a BPT of 50° C.”

The “break elongation” may be measured in conformity with JIS A 5759.

The optical member 1 needs to have a breaking strength of not less than 100 N. When the breaking strength of the optical member 1 is less than 100 N, the optical member 1 fails to have a sufficiently high glass scattering prevention performance. From the perspective of further enhancing the glass scattering prevention performance, the breaking strength of the optical member 1 is preferably not less than 150 N.

Additionally, the breaking strength of the optical member 1 may be controlled, for example, by selecting the first optical layer 3a and/or the second optical layer 3b as appropriate while focusing attention on the storage moduli thereof, or by adjusting the thickness(es) of the transparent substrates and/or the optical layer.

The “breaking strength” may be measured in conformity with JIS A 5759.

In the optical member 1, a laminated body of the optical layer 3 and the second transparent substrate 2b has a transmittance of not more than 20% for ultraviolet rays with wavelengths of not less than 300 nm and not more than 325 nm. When the transmittance of the laminated body constituting the optical member 1 for ultraviolet rays with wavelengths of not less than 300 nm and not more than 325 nm is not more than 20%, the amount of ultraviolet radiation reaching the first transparent substrate 2a is reduced. This prevents a decrease in the break elongation, which in turn prevents a decrease in the glass scattering prevention performance, in cases of long-term use of the optical member 1. From the same perspective, the transmittance of the optical member 1 for ultraviolet rays with wavelengths of not less than 300 nm and not more than 325 nm is more preferably not more than 15%, even more preferably not more than 10%.

Additionally, the transmittance of the laminated body for ultraviolet rays with wavelengths of not less than 300 nm and not more than 325 nm may be controlled, for example, by adjusting the total thickness of the optical member 1, or, by adding the ultraviolet ray absorbing agent to the first optical layer 3a and/or the second optical layer 3b or adjusting the content of the ultraviolet ray absorbing agent.

The “transmittance for ultraviolet rays” may be measured according to a method described with respect to Examples.

The optical member 1 preferably has a stiffness of less than 550 mg, more preferably less than 280 mg. When the stiffness of the optical member 1 is less than 550 mg, a highly professional installer may apply the optical member 1 to the subject 10 of application, such as window glass, easily by contact cutting. When the stiffness of the optical member 1 is less than 280 mg, a number of installers may apply the optical member 1 to the subject 10 of application, such as window glass, easily by contact cutting.

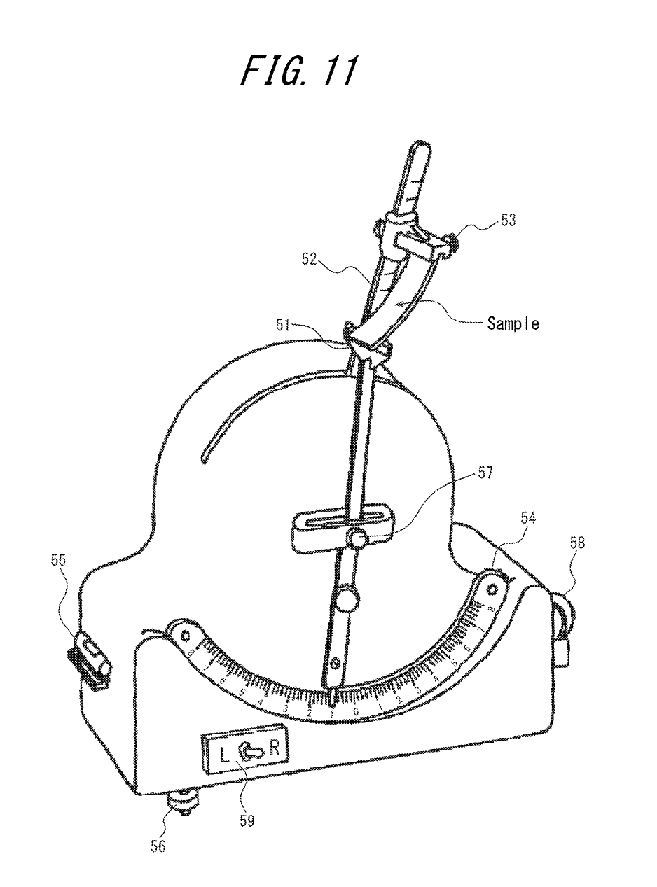

The “stiffness” of the optical member 1 may be measured by using an apparatus illustrated in FIG. 11. In the illustrated apparatus, reference numeral 51 denotes a pendulum, 52 denotes a movable arm, 53 denotes a chuck, 54 denotes a dial, 55 denotes a rod level, 56 denotes a level screw, 57 denotes a bearing, 58 denotes a weight, and 59 denotes a switch button. Firstly, a sample of the optical member 1 that has a predetermined dimension is mounted on the chuck 53, which is attached to the movable arm 52. Subsequently, when the sample mounted on the chuck 53 is positioned on the left side of the pendulum 51, the switch 59 is turned to the right side (R), and when the sample is positioned on the right side of the pendulum 51, the switch 59 is turned to the left side (L). In this state, the movable arm 52 is activated. Then, a scale R_{G} at the moment when the pendulum 51 is detached from a free end of the sample is read. Herein, providing that the sample used has a length of 3×½″ and a width of 1″ and that the weight 58 of 5 g is placed in a 1″ hole, stiffness (in the unit of mg) is obtained by the following formula. Note that “89” in the following formula represents a value (mg) of one scale of the dial 54 when the weight 58 of 5 g is placed in the hole.

Stiffness=R_{G}×89

A Gurley stiffness tester manufactured by Toyo Seiki Seisaku-Sho, Ltd. is one example of the apparatus used to measure the aforementioned stiffness.

The optical member 1 preferably has transparency. In detail, in the optical member 1, a value of transmission image clarity in the wavelength band where the optical member 1 has transmitting properties is preferably not less than 50, more preferably not less than 60, and even more preferably not less than 75 when an optical comb of 0.5 mm is used. When the value of transmission image clarity is less than 50, a transmission image tends to look blurred. When the value of transmission image clarity is not less than 50 and less than 60, there are no problems in daily life, although depending on outdoor brightness. When the value of transmission image clarity is not less than 60 and less than 75, the outside view may be clearly seen, although only a very bright object, such as a light source, causes an unpleasant diffraction pattern. When the value of transmission image clarity is not less than 75, an unpleasant diffraction pattern is hardly recognized. Furthermore, in the optical member 1, a sum of values of transmission image clarity measured by using optical combs of 0.125 mm, 0.5 mm, 1.0 mm, and 2.0 mm is preferably not less than 230, more preferably not less than 270, and even more preferably not less than 350. When the value of transmission image clarity is less than 230, a transmission image tends to look blurred. When the value of transmission image clarity is not less than 230 and less than 270, there are no problems in daily life, although depending on outdoor brightness. When the value of transmission image clarity is not less than 270 and less than 350, the outside view may be clearly seen, although only a very bright object, such as a light source, causes an unpleasant diffraction pattern. When the value of transmission image clarity is not less than 350, an unpleasant diffraction pattern is hardly recognized. Herein, a value of transmission image clarity is measured in conformity with JIS K7105 by using ICM-1 T manufactured by Suga Test Instruments Co., Ltd. Note that, when a wavelength to be transmitted differs from that of the D65 light source, it is preferable to conduct calibration using a filter having the wavelength to be transmitted before carrying out measurements.

In the optical member 1, the percentage of haze occurring in the wavelength band where the optical member 1 has transmitting properties is not limited to a particular value and may be determined appropriately according to purposes. However, the haze is preferably not more than 6%, more preferably not more than 4%, and even more preferably not more than 2%. The reason is that, when the haze is more than 6%, the transmitted light is scattered, possibly obscuring a view. Herein, the haze is measured according to a measurement method defined by JIS K7136 by using HM-150 manufactured by Murakami Color Research Laboratory Co., Ltd. Note that, when a wavelength to be transmitted differs from that of the D65 light source, it is preferable to conduct calibration using a filter having the wavelength to be transmitted before carrying out measurements.

### <Method of Applying Optical Member>

A window member installed in recent high-rise architectures, such as buildings, generally has a rectangular shape having a vertical width greater than a horizontal width. Accordingly, a description is given below of an example in which the strip-shaped optical member 1, which is wounded into a roll, is applied to the subject 10 of application having the aforementioned shape.

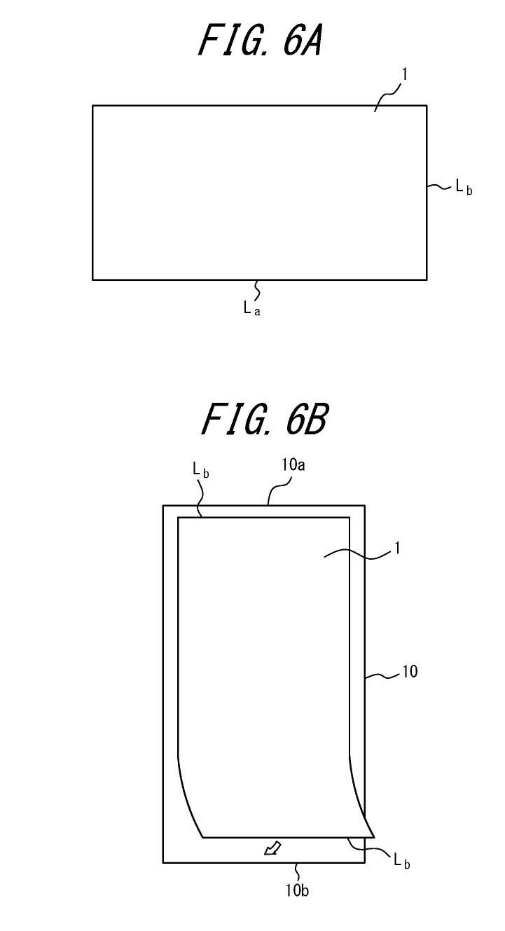

Firstly, a strip of the optical member 1 is removed from the roll (which is so-called stock roll) of the wound optical member 1. The removed strip of the optical member 1 is cut suitably for the shape of the subject 10 of application, to which the optical member 1 is to be applied. Thus, a rectangular piece of optical member 1 (which is called rectangular optical member 1) is obtained. As illustrated in FIG. 6A, the rectangular optical member 1 has a pair of opposing long sides La and a pair of opposing short sides Lb. Subsequently, one of the short sides Lb of the cut optical member 1 is aligned with a short side 10a, which is positioned at an upper end of the rectangular subject 10 of application. After that, as illustrated in FIG. 6B, the rectangular optical member 1 is gradually applied to the subject 10 of application in a direction from the upper end toward a lower end thereof via the application layer 5 or the like. Thus, the other one of the short sides Lb of the optical member 1 is aligned with a short side 10b, which is positioned at another end of the rectangular subject 10 of application. Subsequently, when necessary, bubbles entrapped between the subject 10 of application and the optical member 1 are removed, for example, by pressing a surface of the optical member 1, applied to the subject 10 of application. The above processes are used to apply the rectangular optical member 1 to the subject 10 of application.

### <Apparatus Used to Produce Optical Member>

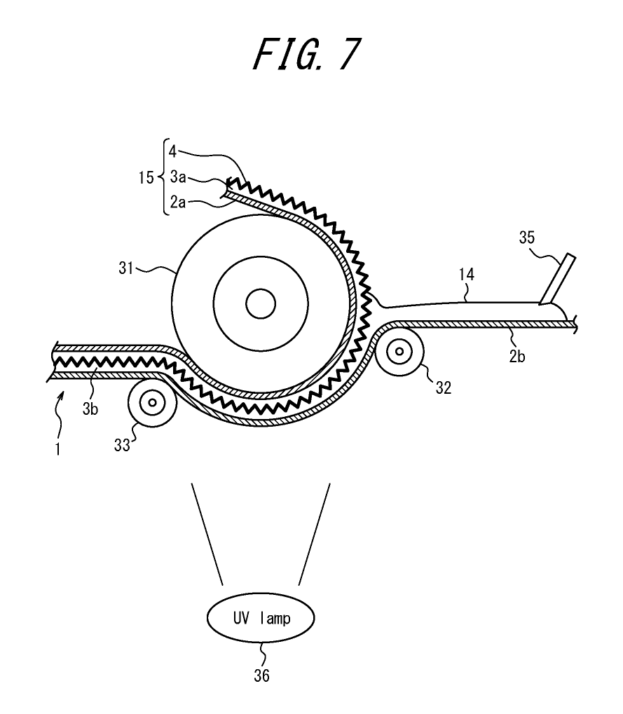

FIG. 7 is a schematic view illustrating a configuration example of an apparatus used to produce the optical member 1. As illustrated in FIG. 7, the production apparatus includes laminating rolls 31 and 32, a guide roll 33, a coating device 35, and an irradiation device 36.

The laminating rolls 31 and 32 are configured to nip the first transparent substrate 2a provided with the reflective layer 4 and the first optical layer 3a (which may be collectively called transparent substrate 15 including layers) and the second transparent substrate 2b therebetween. Herein, the transparent substrate 15 including layers is configured by the first transparent substrate 2a, the first optical layer 3a, which is disposed on one surface of the first transparent substrate 2a, and the reflective layer 4, which is formed on a surface of the optical layer 3a. The guide roll 33 is arranged on a conveying path in the production apparatus to convey the strip-shaped optical member 1. Materials of the laminating rolls 31 and 32 and the guide roll 33 are not limited to particular ones. Metal, such as stainless, rubber, silicone, or the like may be selected appropriately in accordance with desired roll characteristics.

As the coating device 35, a device including a coating unit, such as a coater, may be used. As the coater, a gravure coater, a wire bar, a die, or other coaters may be used as appropriate in consideration of, for example, physical properties of the resin composition to be applied. The irradiation device 36 may be configured to emit ionizing rays, such as electron rays, ultraviolet rays, visible rays, or gamma rays. In this example, a UV lamp configured to emit ultraviolet rays is used as the irradiation device 36.

### <Method of Producing Optical Member>

With reference to FIGS. 7 to 10C, a description is given below of an example of a method of producing the optical member 1. Note that a part or an entity of production processes described below is preferably performed according to the roll-to-roll method.

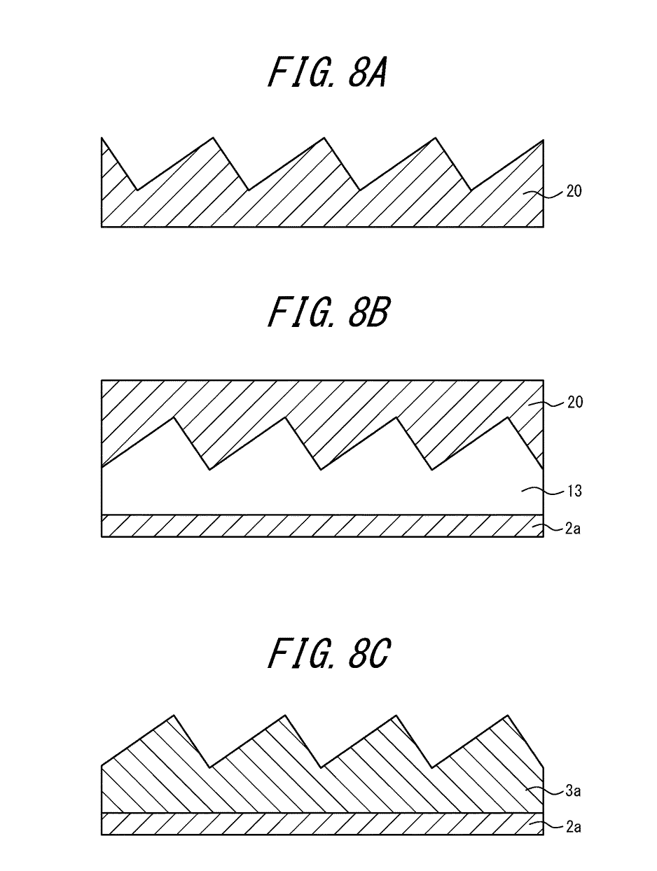

Firstly, as illustrated in FIG. 8A, a mold having the concave-convex shape to be imparted to the first optical layer 3a or a mold (replica) 20, which has a reversed shape of the above mold is formed, for example, by bite machining or laser machining.

Secondly, the film-shaped first transparent substrate 2a is fed from the roll, and the first transparent substrate 2a is coated with a resin composition 13. Subsequently, as illustrated in FIG. 8B, the shape of the mold 20 is transferred by pressing the mold 20 against the resin composition 13, and the resin composition 13 is cured by irradiation with active energy rays, heating, or the like. After that, the mold 20 is removed. Thus, the first optical layer 3a, which has the concave-convex shape as illustrated in FIG. 8C, is formed on the first transparent substrate 2a.

Additionally, the resin composition 13 is the same as the resin composition described earlier with respect to the first optical layer and the second optical layer.

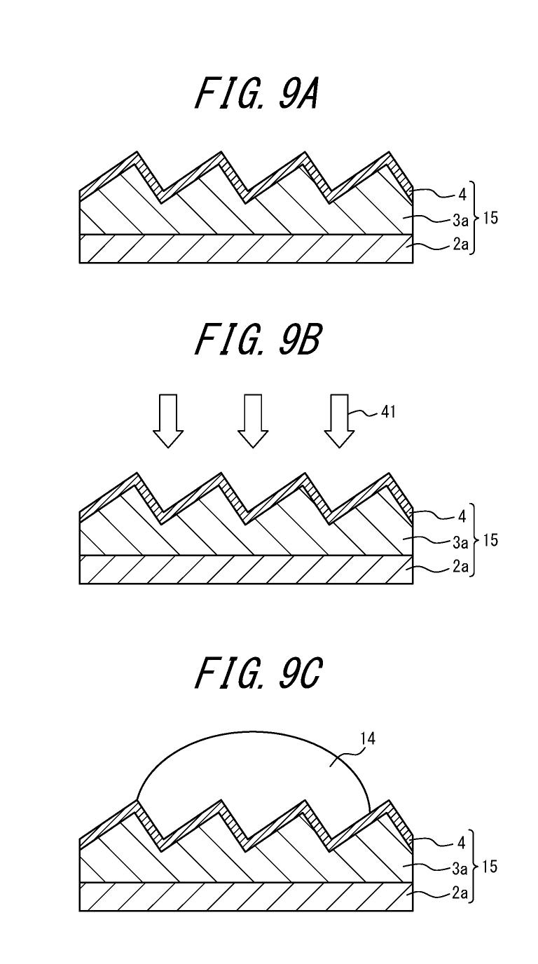

Subsequently, as illustrated in FIG. 9A, the reflective layer 4 is formed on one main surface of the first optical layer 3a, thereby forming the transparent substrate 15 including layers. The reflective layer 4 may be formed, for example, by a sputtering, an evaporation, a Chemical Vapor Deposition (CVD), a dip coating, a die coating, a wet coating, or a spray coating method. After that, as illustrated in FIG. 9B, the reflective layer 4 is subjected to an annealing treatment 41 as needed. The annealing treatment is conducted at a temperature in the range of, for example, not less than 100° C. and not more than 250° C.

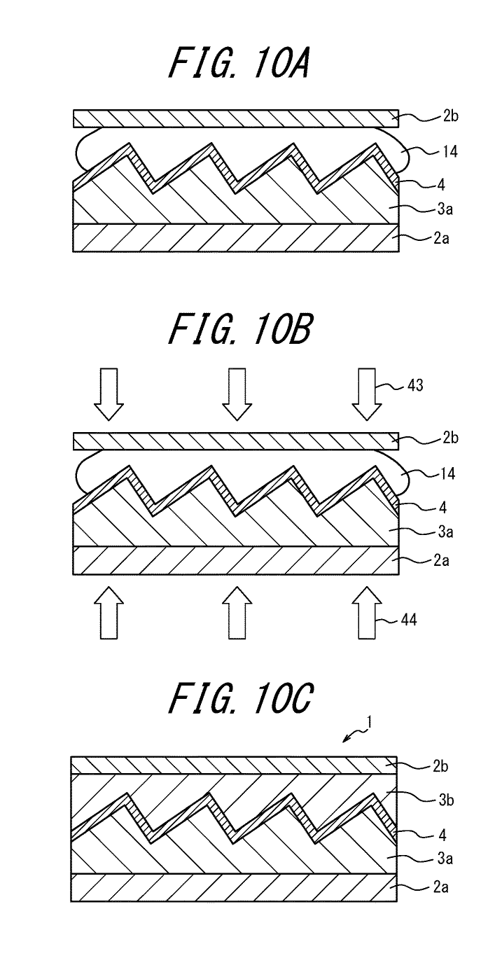

Subsequently, as illustrated in FIG. 9C, the reflective layer 4 is coated with a resin composition 14 in an uncured state. Additionally, the resin composition 14 is the same as the resin composition described earlier with respect to the first optical layer and the second optical layer. After that, as illustrated in FIG. 10A, the second transparent substrate 2b is placed over the resin composition 14, and thus, a laminated body is formed. Subsequently, as illustrated in FIG. 10B, the resin composition 14 is cured, for example, by an active energy ray irradiation treatment 43 or a heating treatment 43, while pressure 44 is applied to the laminated body. The pressure 44 applied to the laminated body is preferably in the range of not less than 0.01 MPa and not more than 1 MPa. With a pressure of less than 0.01 MPa, a problem may occur in terms of travelling properties of the optical member 1 in the apparatus. On the other hand, with a pressure of more than 1 MPa, the use of a metal roll is required as a pressurizing roll, and this tends to generate pressure irregularity. With the above processes, as illustrated in FIG. 10C, the second optical layer 3b is formed on the reflective layer 4, and the second transparent substrate 2b is disposed on the second optical layer 3b. Thus, the optical member 1 is obtained.

Now, a concrete description is give of the method of forming the optical member 1 by using the production apparatus illustrated in FIG. 7. Firstly, the second transparent substrate 2b is fed from a substrate supply roll which is not illustrated. The fed second transparent substrate 2b passes below the coating device 35. Subsequently, the second transparent substrate 2b, which passes below the coating device 35, is coated with the resin composition 14 by using the coating device 35. After that, the second transparent substrate 2b, which is coated with the resin composition 14, is conveyed toward the laminating rolls 31 and 32. On the other hand, the transparent substrate 15 including layers (i.e., the first transparent substrate 2a, provided with the reflective layer 4 and the first optical layer 3a) is fed from a supply roll which is not illustrated and is conveyed toward the laminating rolls 31 and 32.

Subsequently, the conveyed second transparent substrate 2b and transparent substrate 15 including layers are sandwiched between the laminating rolls 31 and 32 to prevent bubbles from being entrapped between the second transparent substrate 2b and the transparent substrate 15 including layers. Thus, the transparent substrate 15 including layers is laminated on the second transparent substrate 2b. After that, the second transparent substrate 2b, together with the transparent substrate 15 including layers that is laminated thereon, is conveyed along an outer circumferential surface of the laminating roll 31. At the same time, the irradiation device 36 is operated to irradiate the resin composition 14 with active energy rays from the side of the second transparent substrate 2b, thereby curing the resin composition 14. Consequently, the transparent substrate 15 including layers is applied to the second transparent substrate 2b via the second optical layer 3b, which is made of the cured resin composition 14. Thus, the strip-shaped optical member 1 is fabricated. Subsequently, the fabricated strip-shaped optical member 1 is wound by a wind-up roll which is not illustrated. Thus, a stock roll in the form of a wound roll of the strip-shaped optical member 1 is obtained.

### <Intended Use of Optical Member>

In use, the optical member 1 may be applied to the subject 10 of application, such as window glass, via the application layer 5, which is formed by the adhesive or the like. The optical member 1 is suitable to be applied to an inner wall member, an outer wall member, a window material, and a wall material. Examples of the window material may include an architectural window material for a high-rise building, a house, or the like, and a window material for a vehicle. Additionally, the subject 10 of application is not limited to single-layer glass window and may be special glass, such as multilayer glass. Furthermore, the subject 10 of application is not limited to a glass-made object and may be an object made of a high polymeric material having transparency. The optical member 1 may be applied to the indoor side or the outdoor side of the subject 10 of application.

The optical member 1 is also suitable for use as a slat (solar shading member) of a blind device or a screen (solar shading member) of a roll curtain. Furthermore, the optical member 1 is suitable to be installed in a light collection portion of a fitting (an interior member or an exterior member), such as a paper sliding door.

Moreover, the optical member 1 may be used in combination with an additional heat-ray cut-off film. For example, a light absorption coating may be applied at an interface (i.e., on an outermost surface of the optical member 1) between air and the optical member 1.

### (Window Material)

A window material according to one of embodiments is characterized in that it includes the above-described optical member. Since the window material includes the above-described optical member, even when the optical member is produced by water application operation, residual water or the like is reduced, and the favorable appearance is maintained. Furthermore, since the window material includes the above-described optical member, a high glass scattering prevention performance is maintained over long-term use.

Additionally, the window material only needs to include the above-described optical member. The shape and dimension of the window material, a type of the subject of application that constitutes the window material, and a surface of the optical member that is applied to the subject of application, etc. are not limited to particular examples.

### EXAMPLES

The following describes Examples of the optical member according to the present disclosure along with Comparative Examples. However, the present disclosure is not limited to these Examples at all.

### Example 1

Firstly, a prism shape configured by a one-dimensional array of a plurality of structures was imparted to a mold roll by bite machining. Furthermore, a PET film (“A4300” manufactured by Toyobo Co., Ltd. and with a thickness of 50 μm) was prepared as a first transparent substrate (to be disposed on the indoor side). One surface of the prepared PET film was coated with a resin composition containing an ultraviolet ray-curable resin, and the resin composition was cured by irradiation with ultraviolet rays. Thus, a hard coat layer with a thickness of 4 μm was formed.

Secondly, nip rolls were prepared. The aforementioned PET film as the first transparent substrate was fed between the aforementioned mold roll and one of the nip rolls to travel therebetween, with a surface of the PET film on which the hard coat layer was not formed being facing to the mold roll. At this time, a resin composition was supplied and nipped between the mold roll and the PET film. Then, the resin composition was irradiated with ultraviolet rays from the side of the PET film for curing, and thus, a first optical layer was fabricated. Table 1 illustrates components of the resin composition used to fabricate the first optical layer.

Subsequently, on a surface of the first optical layer, Nb₂O₅ (30 nm)/AgPdCu (10 nm)/Al₂O₃—ZnO (5 nm)/Nb₂O₅ (70 nm)/AgPdCu (10 nm)/Al₂O₃—ZnO (4 nm)/Nb₂O₅ (25 nm)/Al₂O₃—ZnO (4 nm) were deposited in the stated order by the sputtering method, to form a reflective layer configured to reflect near-infrared light. Thus, a transparent substrate including layers (i.e., the first transparent substrate provided with the reflective layer and the first optical layer) was obtained.

After the formation of the reflective layer, the transparent substrate including layers and a PET film (“A4300” manufactured by Toyobo Co., Ltd. and with a thickness of 23 μm) as a second transparent substrate (to be disposed on the outdoor side) were arranged to travel between the nip rolls, with a surface of the transparent substrate on which the reflective layer was formed being opposed to the PET film. At this time, the resin composition same as that used to fabricate the first optical layer was supplied and nipped between the above surface and the PET film. By doing so, it was controlled into a predetermined thickness, and moreover, bubbles were expelled. Subsequently, the resin composition was irradiated with ultraviolet rays through the PET film for curing. Thus, a second optical layer was formed. The above processes were used to obtain an optical member. Additionally, in Example 1, the thickness of an optical layer (i.e., a layer including the first optical layer, the reflective layer, and the second optical layer) was 30 μm.

Subsequently, the optical member was applied to transparent glass via an acryl-based adhesive layer with a thickness of 20 μm that was disposed on a surface of the second transparent substrate (to be disposed on the outdoor side) according to an installation method using water application. Thus, a glass sample was fabricated.

Furthermore, the aforementioned resin composition used to fabricate the first optical layer and the second optical layer was prepared separately to form a film with a thickness of 30 μm. The formed film was irradiated with ultraviolet rays, and thus, a cured resin film was prepared. For the prepared resin film, the storage modulus at 25° C. at a frequency of 1 Hz was measured by using “E4000” manufactured by UBM. The measurement value may be regarded as the storage modulus of each of the first optical layer and the second optical layer.

### Examples 2 to 4

An optical member and a glass sample were fabricated in the same manner as Example 1 except that the components of the resin composition used to fabricate the first optical layer and the second optical layer of Example 1 were changed as illustrated in Table 1. Furthermore, the storage modulus of the first optical layer and the second optical layer was measured.

### Example 5

An optical member and a glass sample were fabricated in the same manner as Example 1 except that the thickness of the optical layer (i.e., the layer including the first optical layer, the reflective layer, and the second optical layer) was changed from 30 μm of Example 1 to 20 μm.

### Example 6

An optical member and a glass sample were fabricated in the same manner as Example 1 except that the thickness of the optical layer (i.e., the layer including the first optical layer, the reflective layer, and the second optical layer) was changed from 30 μm of Example 1 to 40 μm.

### Comparative Examples 1 and 2

An optical member and a glass sample were fabricated in the same manner as Example 1 except that the components of the resin composition used to fabricate the first optical layer and the second optical layer of Example 1 were changed as illustrated in Table 1. Furthermore, the storage modulus of the first optical layer and the second optical layer was measured.

### Comparative Example 3

An optical member and a glass sample were fabricated in the same manner as Example 1 except that the thickness of the optical layer (i.e., the layer including the first optical layer, the reflective layer, and the second optical layer) was changed from 30 μm of Example 1 to 50 μm.

### Comparative Example 4

An optical member and a glass sample were fabricated in the same manner as Example 1 except that the PET film with a thickness of 23 μm as the second transparent substrate (to be disposed on the outdoor side) of Example 1 was replaced by a PET film (“A4300” manufactured by Toyobo Co., Ltd.) with a thickness of 50 μm.

### Comparative Example 5

An optical member and a glass sample were fabricated in the same manner as Example 1 except that the PET film with a thickness of 50 μm as the first transparent substrate (to be disposed on the indoor side) of Example 1 was replaced by a PET film (“A4300” manufactured by Toyobo Co., Ltd.) with a thickness of 75 μm.

### Comparative Example 6

An optical member (which did not include the second transparent substrate [to be disposed on the outdoor side]) and a glass sample were fabricated in the same manner as Example 1 except that the second transparent substrate (to be disposed on the outdoor side) of the Example 1 was omitted and that the surface of the transparent substrate including layers on which the reflective layer was formed was coated with the resin composition, which was then irradiated with ultraviolet rays for curing, to form the second optical layer.

### Comparative Example 7

A PET film (“A4300” manufactured by Toyobo Co., Ltd. and with a thickness of 50 μm) was prepared as the first transparent substrate (to be disposed on the indoor side). One surface of the prepared PET film was coated with a resin composition containing an ultraviolet ray-curable resin, and the resin composition was cured by irradiation with ultraviolet rays. Thus, the hard coat layer with a thickness of 4 μm was formed. Then, on a surface of the above PET film on which the hard coat layer was not formed, Nb₂O₅ (30 nm)/AgPdCu (10 nm)/Al₂O₃—ZnO (5 nm)/Nb₂O₅ (70 nm)/AgPdCu(10 nm)/Al₂O₃—ZnO (4 nm)/Nb₂O₅ (25 nm)/Al₂O₃—ZnO (4 nm) were deposited in the stated order by a vacuum sputtering method, to form the reflective layer. Thus, an optical member (which did not include the second transparent substrate [to be disposed on the outdoor side], the first optical layer, and the second optical layer) was obtained.

Subsequently, the obtained optical member was applied to transparent glass via an acryl-based adhesive layer (containing 1 mass % of the ultraviolet ray absorbing agent [“Tinuvin 479” manufactured by BASF]) with a thickness of 20 μm that was disposed on a surface of the reflective layer. Thus, a glass sample was fabricated.

### Comparative Example 8

An optical member and a glass sample were fabricated in the same manner as Example 1 except that the components of the resin composition used to fabricate the first optical layer and the second optical layer of Example 1 were changed as illustrated in Table 1. Furthermore, the storage modulus of the first optical layer and the second optical layer was measured.

For each of the optical members or the glass samples fabricated in Examples 1 to 6 and Comparative Examples 1 to 8, the stiffness, the transmittance for ultraviolet rays, the breaking strength, and the break elongation before and after the weatherability test were measured according to the following procedure. Furthermore, at the time of fabricating the glass sample, the workability of water application was evaluated according to the following procedure.

### (Measurement of Stiffness)

Each of the optical members fabricated in Examples 1 to 6 was cut into a piece with a length of 3×½″ and a width of 1″ to be used as a sample. For the sample, the stiffness was measured by the Gurley stiffness tester manufactured by Toyo Seiki Seisaku-Sho, Ltd. At this time, the weight 58 of 5 g was placed in the 1″ hole in the tester. As a result, it has been confirmed that the optical member according to each of Examples 1 to 6 has a stiffness of less than 280 mg.

### (Measurement of Transmittance for Ultraviolet Rays)

Firstly, a laminated body of the optical layer and the second transparent substrate was obtained by peeling the first transparent substrate from each of the fabricated optical members according to a commonly-used method. For the obtained laminated body, the transmittance for ultraviolet rays with wavelengths of not less than 300 nm and not more than 325 nm was measured by using a spectrophotometer (“U-4100” manufactured by Hitachi High-Technologies Corporation). Table 1 shows a result of the measurement.

### (Measurement of Breaking Strength)

In conformity with JIS A 5759 in terms of conditions and the shape of the sample, the breaking strength was measured by using “Autograph AG-X” manufactured by Shimadzu Corporation. In conformity with JIS A 5759, when the breaking strength was not less than 100 N, it was determined as good, and when the breaking strength was less than 100 N, it was determined as bad. Table 1 shows a result of the measurement.

### (Measurement of Break Elongation Before and After Weatherability Test)

Firstly, for each of the fabricated glass samples, the break elongation was measured by using “Autograph AG-X” manufactured by Shimadzu Corporation in conformity with JIS A 5759 in terms of conditions and the shape of the sample.

The measurement was followed by the weatherability test, in which the glass sample was irradiated with ultraviolet rays for 500 hours under the conditions of an illuminance of 650 W/m² and a BPT of 50° C. by using “Super UV tester SUV-W-151” manufactured by Iwasaki Electric Co., Ltd. Subsequently, for each glass sample after the weatherability test, the break elongation was measured in the same manner as described above.

In conformity with JIS A 5759, when the break elongation was not less than 60%, it was determined as good, and when the break elongation was less than 60%, it was determined as bad. Table 1 shows a result of the measurement.

### (Evaluation of Workability of Water Application)

Each optical member was applied to transparent glass according to the installation method using water application and left at normal temperature for 4 hours. After being left, the glass sample was observed in terms of an area in which residual water was found, within an installed area of 1 m². When the observed area was less than 1 cm², it was determined as good, and the observed are was not less than 1 cm², it was determined as bad. Table 1 shows a result of the observation.

TABLE 1

| | | | | | | | | | | | Com- |
|---|---|---|---|---|---|---|---|---|---|---|---|
| | | | | | | | | | | | parative |
| | | | | | Exam- | Exam- | Exam- | Exam- | Exam- | Exam- | Exam- |
| | | | | | ple 1 | ple 2 | ple 3 | ple 4 | ple 5 | ple 6 | ple 1 |
| Hard coat layer | | Thickness | | [μm] | 4 | 4 | 4 | 4 | 4 | 4 | 4 |
| First transparent | | Thickness | | [μm] | 50 | 50 | 50 | 50 | 50 | 50 | 50 |
| substrate (to | | | | | | | | | | | |
| be disposed on | | | | | | | | | | | |
| indoor side) | | | | | | | | | | | |
| Optical | First | Compo- | Urethane acrylate A *¹ | [mass %] | 50 | 50 | 40 | 0 | 50 | 50 | 50 |
| layer | optical | nents | Urethane acrylate B *² | | 0 | 0 | 0 | 90 | 0 | 0 | 0 |
| | layer and | | Urethane acrylate C *³ | | 0 | 0 | 0 | 0 | 0 | 0 | 0 |
| | Second | | Benzyl methacrylate *⁴ | | 46 | 44 | 56 | 0 | 46 | 46 | 47 |
| | optical | | Photoinitiation *⁵ | | 3 | 3 | 3 | 3 | 3 | 3 | 3 |
| | layer | | Ultraviolet ray | | 1 | 3 | 1 | 1 | 1 | 1 | 0 |
| | | | absorbing agent *⁶ | | | | | | | | |
| | | | Cross-linking agent *⁷ | | 0 | 0 | 0 | 6 | 0 | 0 | 0 |
| | | | Total | | 100 | 100 | 100 | 100 | 100 | 100 | 100 |
| | | Storage Modulus | | [GPa] | 4.2 | 4.2 | 3.2 | 1.8 | 4.2 | 4.2 | 4.2 |
| | Thickness | | | [μm] | 30 | 30 | 30 | 30 | 20 | 40 | 30 |
| Second transparent | | Thickness | | [μm] | 23 | 23 | 23 | 23 | 23 | 23 | 23 |
| substrate (to | | | | | | | | | | | |
| be disposed on | | | | | | | | | | | |
| outdoor side) | | | | | | | | | | | |
| Optical member | | Total thickness | | [μm] | 107 | 107 | 107 | 107 | 97 | 117 | 107 |
| | | Transmittance for | | [%] | 17 | 13 | 17 | 17 | 17 | 17 | 25 |
| | | ultraviolet rays | | | | | | | | | |
| | | Breaking strength | | [%] | 290 | 290 | 250 | 180 | 230 | 340 | 290 |
| | | | | | Good | Good | Good | Good | Good | Good | Good |
| | | Break elongation before | | [%] | 71 | 71 | 75 | 73 | 75 | 67 | 71 |
| | | weatherability test | | | Good | Good | Good | Good | Good | Good | Good |
| | | Break elongation after | | [%] | 65 | 67 | 66 | 70 | 67 | 61 | 55 |
| | | weatherability test | | | Good | Good | Good | Good | Good | Good | Bad |
| | | Workability of water application | | | Good | Good | Good | Good | Good | Good | Good |
| | | | | | Com- | Com- | Com- | Com- | Com- | Com- | Com- |
| | | | | | parative | parative | parative | parative | parative | parative | parative |
| | | | | | Exam- | Exam- | Exam- | Exam- | Exam- | Exam- | Exam- |
| | | | | | ple 2 | ple 3 | ple 4 | ple 5 | ple 6 | ple 7 | ple 8 |
| Hard coat layer | | Thickness | | [μm] | 4 | 4 | 4 | 4 | 4 | 4 | 4 |
| First transparent | | Thickness | | [μm] | 50 | 50 | 50 | 75 | 50 | 50 | 50 |
| substrate (to | | | | | | | | | | | |
| be disposed on | | | | | | | | | | | |
| indoor side) | | | | | | | | | | | |
| Optical | First | Compo- | Urethane acrylate A *¹ | [mass %] | 65 | 50 | 50 | 50 | 50 | N/A | 0 |
| layer | optical | nents | Urethane acrylate B *² | | 0 | 0 | 0 | 0 | 0 | | 0 |
| | layer and | | Urethane acrylate C *³ | | 0 | 0 | 0 | 0 | 0 | | 48 |
| | Second | | Benzyl methacrylate *⁴ | | 31 | 46 | 46 | 46 | 46 | | 48 |
| | optical | | Photoinitiation *⁵ | | 3 | 3 | 3 | 3 | 3 | | 3 |
| | layer | | Ultraviolet ray | | 1 | 1 | 1 | 1 | 1 | | 1 |
| | | | absorbing agent *⁶ | | | | | | | | |
| | | | Cross-linking agent *⁷ | | 0 | 0 | 0 | 0 | 0 | | 0 |
| | | | Total | | 100 | 100 | 100 | 100 | 100 | | 100 |

| | | | | | | | |
|---|---|---|---|---|---|---|---|
| Storage Modulus | [GPa] | 5.0 | 4.3 | 4.2 | 4.2 | 4.2 | 0.6 |

| | | | | | | | |
|---|---|---|---|---|---|---|---|
| Thickness | [μm] | 30 | 50 | 30 | 30 | 30 | 30 |

| | | | | | | | | | |
|---|---|---|---|---|---|---|---|---|---|
| Second transparent | Thickness | [μm] | 23 | 23 | 50 | 23 | N/A | N/A | 23 |
| substrate (to | | | | | | | | | |
| be disposed on | | | | | | | | | |
| outdoor side) | | | | | | | | | |
| Optical member | Total thickness | [μm] | 107 | 127 | 134 | 132 | 84 | 54 | 107 |
| | Transmittance for | [%] | 17 | 17 | 15 | 17 | 25 | 27*⁸ | 17 |
| | ultraviolet rays | | | | | | | | |
| | Breaking strength | [%] | 300 | 290 | 290 | 280 | 300 | 190 | 85 |
| | | | Good | Good | Good | Good | Good | Good | Bad |
| | Break elongation before | [%] | 50 | 56 | 73 | 70 | 65 | 30 | 90 |
| | weatherability test | | Bad | Bad | Good | Good | Good | Good | Good |
| | Break elongation after | [%] | — | — | 69 | 63 | 50 | 55 | 81 |
| | weatherability test | | | | Good | Good | Bad | Bad | Good |

| | | | | | | | |
|---|---|---|---|---|---|---|---|
| Workability of water application | Good | Bad | Bad | Bad | Good | Good | Good |

*¹ Urethane acrylate A: “CN991” manufactured by Sartomer Company, Inc.
*² Urethane acrylate B: “Aronix ® (Aronix is a registered trademark in Japan, other countries, or both)” manufactured by Toagosei Co., Ltd.
*³ Urethane acrylate C: “UF-8001G” manufactured by Kyoeisha Chemical Co., Ltd.
*⁴ Benzyl methacrylate: “Lite Ester BZ” manufactured by Kyoeisha Chemical Co., Ltd.
*⁵ Photoinitiator: “Irgacure 184” manufactured by Nihon Kayaku Co., Ltd.
*⁶ Ultraviolet ray absorbing agent: triazine-based “Tinuvin 479” manufactured by BASF.
*⁷ Cross-linking agent: “T2325” manufactured by Tokyo Kasei Kogyo Co., Ltd.
*⁸Transmittance for ultraviolet rays of glass sample not including adhesive layer.

As can be seen clearly from Table 1, the optical members according to Examples of the present disclosure all have favorable workability of water application with respect to the subject of application, such as window glass. Furthermore, in each optical member according to Examples of the present disclosure, the break elongation before the weatherability test and the break elongation after the weatherability test are both not less than 60%, and this demonstrates that the optical member exhibits a high glass scattering prevention performance over long-term use.

### INDUSTRIAL APPLICABILITY

The present disclosure provides an optical member and a window material including the optical member that provide excellent workability of water application with respect to the subject of application, such as window glass, and that also exhibit a high glass scattering prevention performance over long-term use.

1. An optical member, comprising:
an optical layer including a first optical layer having a surface with a concave-convex shape, a reflective layer disposed on the surface with the concave-convex shape of the first optical layer, and a second optical layer disposed on the reflective layer;
a first transparent substrate disposed on a side of the first optical layer included in the optical layer; and
a second transparent substrate disposed on a side of the second optical layer included in the optical layer, wherein
the reflective layer is configured to reflect near-infrared light,
the first transparent substrate and the second transparent substrate are made of a same material, and
the optical member has
a total thickness of not more than 125 μm,
a breaking strength of not less than 100 N, and
a break elongation before a weatherability test of not less than 60% and a break elongation after the weatherability test of not less than 60%.

2. The optical member according to claim 1, wherein one of the first transparent substrate and the second transparent substrate has a thickness greater than a thickness of another one of the first transparent substrate and the second transparent substrate, and the thickness of the one of the first transparent substrate and the second transparent substrate is not less than 50 μm.

3. The optical member according to claim 1, wherein the concave-convex shape of the first optical layer comprises one of a prism shape, a lenticular shape, a semi-spherical shape, and a corner-cube shape, which is configured by a one-dimensional array or a two-dimensional array of a plurality of structures.

4. The optical member according to claim 1, wherein the first optical layer and the second optical layer each contain one of a thermoplastic resin, an active energy ray-curable resin, and a thermosetting resin.

5. The optical member according to claim 1, wherein at least one of the first optical layer and the second optical layer contains a ultraviolet absorbing agent.

6. The optical member according to claim 1, wherein the first optical layer and the second optical layer each have a storage modulus of not less than 1.0 GPa and not more than 4.5 GPa at 25° C. at 1 Hz.

7. The optical member according to claim 1, wherein a laminated body of the optical layer and the second transparent substrate has a transmittance of not more than 20% for ultraviolet rays with wavelengths of not less than 300 nm and not more than 325 nm.

8. A window material comprising the optical member according to claim 1.
